(19) United States
(12) Patent Application Publication
(10) Pub. No.: US 2013/0146630 A1
(43) Pub. Date: Jun. 13, 2013

(54) Transport Device Removable Bucket

(71) Applicant: Dale Cooper, American Falls, ID (US)

(72) Inventor: Dale Cooper, American Falls, ID (US)

(21) Appl. No.: 13/528,962

(22) Filed: Jun. 21, 2012

Related U.S. Application Data
(63) Continuation of application No. 13/420,396, filed on Mar. 14, 2012.
Application No. 13/420,396 is a continuation-in-part of application No. 13/314,345, filed on Dec. 8, 2011.

(51) Int. Cl. B62B 5/00

(52) U.S. Cl. 224/401

(57) ABSTRACT

A transport device removable bucket. The bucket includes a first, second, third and fourth wall defining an enclosure. A first track is on an outside surface of the first wall and a second track is on an outside surface of the second wall. The first and second tracks correspond to one or more arms on a frame assembly. In one embodiment, the first and second tracks are affixed to the first and second walls respectively. In another embodiment, the tracks are integrated into the walls. The tracks can include vertical elements at which point they are attached to the walls. The tracks can be overhangs created by a narrowing of a bottom portion of the removable bucket. In one embodiment, the tracks are substantially v-shaped.

### PRIORITY

This application is a continuation in part of application Ser. No. 13/420,396 filed Mar. 14, 2012, which is a continuation in part of 13/314,345, filed Dec. 8, 2011 and claims priority to the same.

### BACKGROUND

Wheel barrows and other similar devices are used in a wide variety of industries to transport countless materials and items from one location to another. Traditional wheel barrows are typically characterized by a large drum or tub having a single wheel near the nose and two legs near the rear of the tub. Two elongated handles extend from the tub and are grasped by the user to raise the barrow off the legs and thereby place the weight of the contents on the front wheel for transport.

Wheel barrows and other similar devices have several flaws that make them poorly suited for many commercial and domestic applications—including, but not limited to, farming, landscaping, construction and manufacturing. For example, wheel barrows are poorly balanced and tend to tip over when being moved—especially if the tubs are filled or heavily laden. Additionally, because of their shape, existing transport devices are difficult to store—especially in volume—when not in use. They are generally not capable of being stacked one on another. Nor are they generally well-suited for large-volume lateral placement. Moreover, because of their bulkiness, existing transport devices cannot be easily hauled from location to location without a large truck bed or similar hauling space. Transporting such a device in the trunk space of an ordinary vehicle—if it can be fit in at all—prevents the trunk from being completely closed and requires substantial tying down to keep the device from falling out en route, thus putting the device at risk as well as creating danger for others on the road. Additionally, existing transport devices are typically static in their height and cannot be customized to accommodate the size of the person lifting the load.

The present invention in its various embodiments is a transport device that has a removable bucket or tub. It is well-balanced and has a comparatively small storage footprint. It can be adapted to a wide variety of uses and applications and is particularly useful in farming. The present invention in its various embodiments can be easily emptied and has high maneuverability. The device can, in certain embodiments, be consolidated into a relatively small unit that is easily hauled from location to location and can even fit into the trunk of an ordinary vehicle. The device can also include an adjustable handle that allows it to be customized to accommodate the size of the person lifting the load. The present invention in certain embodiments is also advantageous in that the size of the wheels allows it to be maneuvered up and down stairs.

The foregoing advantages as well as others are provided for by the invention in its various embodiments.

### SUMMARY

The invention in its various embodiments includes the following features. It is a transport device removable bucket. The bucket includes a first, second, third and fourth wall defining an enclosure. A first track is on an outside surface of the first wall and a second track is on an outside surface of the second wall. The first and second tracks correspond to one or more arms on a frame assembly. In one embodiment, the first and second tracks are affixed to the first and second walls respectively. In another embodiment, the tracks are integrated into the walls. The tracks can include vertical elements at which point they are attached to the walls. The tracks can be overhangs created by a narrowing of a bottom portion of the removable bucket. In one embodiment, the tracks are substantially v-shaped. In some instances, one or more posts can be included beneath the tracks. These posts can be substantially circular in cross section.

The tracks can include one or more notches that are capable of being engaged by catchers on the frame assembly. In certain embodiments, the tracks are angled. The front wall can be rounded for easier emptying. The back wall can be rounded for easier tipping when transporting. The enclosure can have rounded corners. The bucket can also include wheel wells. In certain embodiments, the bucket is stackable. In yet other embodiments, the bucket includes a pouring edge.

### BRIEF DESCRIPTION OF THE DRAWINGS

FIG. 1 shows a front elevation view of a transport device with the bucket removed according to one embodiment of the present invention.

FIG. 2 shows a front elevation view of a transport device with the bucket attached according to one embodiment of the present invention.

FIG. 3 shows a front elevation view of a partial frame, latch and handle assembly according to one embodiment of the present invention.

FIG. 4 shows a front view of the partial frame, latch and handle assembly depicted in FIG. 3.

FIG. 5 shows a side view of the partial frame, latch and handle assembly depicted in FIG. 3.

FIG. 6 shows a front view of a handle assembly according to one embodiment of the present invention.

FIG. 7 shows a side view of the handle assembly of FIG. 6.

FIG. 8 shows a front elevation view of the handle assembly of FIG. 6.

FIG. 9 shows a side view of a partial frame assembly according to one embodiment of the present invention.

FIG. 10 shows a top view of the partial frame assembly of FIG. 9.

FIG. 11 shows a front view of the partial frame assembly of FIG. 9.

FIG. 12 shows a front elevation view of the partial frame assembly of FIG. 9.

FIG. 13 shows a front view of a partial latch assembly according to one embodiment of the present invention.

FIG. 14 shows a bottom view of the partial latch assembly of FIG. 13.

FIG. 15 shows a front elevation view of the partial latch assembly of FIG. 13.

FIG. 16 shows a side view of the partial latch assembly of FIG. 13.

FIG. 17 shows a side view of a hook latch according to one embodiment of the present invention.

FIG. 18 shows a front view of the hook latch of FIG. 17.

FIG. 19 shows a front elevation view of the hook latch of FIG. 17.

FIG. 20 shows a hook and latch assembly in a latched position according to one embodiment of the present invention.

FIG. 21 shows the hook and latch assembly of FIG. 20 in an unlatched position.

FIG. 22 shows a front elevation view of a removable bucket according to one embodiment of the present invention.

FIG. 23 shows a side view of the removable bucket of FIG. 22.

FIG. 24 is a rear view of the removable bucket of FIG. 22.

FIG. 25 is a front elevation view of a bucket track piece according to one embodiment of the present invention.

FIG. 26 is a broken side view of the track piece of FIG. 25.

FIG. 27 is a front view of the track piece of FIG. 25.

FIG. 28 is a front elevation view of a bucket according to one embodiment of the present invention.

FIG. 29 is a side view of the bucket of FIG. 28.

FIG. 30 is a rear view of the bucket of FIG. 28.

FIG. 31 is a top view of the bucket of FIG. 28.

FIG. 32 is a side view showing a user pushing a transport device according to one embodiment of the present invention.

FIG. 33 is a side view showing a user tipping a transport device according to one embodiment of the present invention.

FIG. 34 is a side view showing a user at one stage of dumping a transport device according to one embodiment of the present invention.

FIG. 35 is a side view showing a user at another stage of dumping a transport device according to one embodiment of the present invention.

FIG. 36 is a side view showing a user at yet another stage of dumping a transport device according to one embodiment of the present invention.

FIG. 37 is a side view showing a user overturning a transport device according to one embodiment of the present invention.

FIG. 38 is a front elevation view of a transport device depicting the rotational movement of the handle assembly according to one embodiment of the present invention.

FIG. 39 is a front elevation view of an arm and wheel according to one embodiment of the present invention.

FIG. 40 is a front view of a handle connection mechanism according to one embodiment of the present invention.

FIG. 41 is a front view of a handle connection mechanism according to one embodiment of the present invention.

FIG. 42 is a front elevation of a removable bucket according to yet another embodiment of the present invention.

FIG. 43 is a front elevation view of a stack of removable buckets according to one embodiment of the present invention.

FIG. 44 shows yet another bucket configuration according to one embodiment of the present invention.

FIGS. 45-46 show a handle rotational locking mechanism according to one embodiment of the present invention.

FIG. 47 shows a front perspective of a transport device with the bucket engaged according to one embodiment of the present invention.

FIG. 48 shows a side view of the transport device of FIG. 47.

FIG. 49 shows an opposite side view of the transport device of FIG. 47.

FIG. 50 shows a front view of the transport device of FIG. 47.

FIG. 51 shows a rear view of the transport device of FIG. 47.

FIG. 52 shows a top view of the transport device of FIG. 47.

FIG. 53 shows a bottom view of the transport device of FIG. 47.

FIG. 54 shows a front perspective of a transport device with the bucket disengaged according to one embodiment of the present invention.

FIG. 55 shows a front perspective of a transport device with the bucket disengaged and fitted with a lid according to one embodiment of the present invention.

FIG. 56 shows a bucket lid according to one embodiment of the present invention.

FIG. 57 shows a front perspective view of a removable bucket according to one embodiment of the present invention.

FIG. 58 shows a front perspective view of a removable bucket according to one embodiment of the present invention.

FIG. 59 shows a front perspective view of a removable bucket according to one embodiment of the present invention.

FIG. 60 shows a front perspective view of a removable bucket according to one embodiment of the present invention.

FIG. 61 shows a front perspective view of a removable bucket according to one embodiment of the present invention.

### DETAILED DESCRIPTION OF THE ILLUSTRATED INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

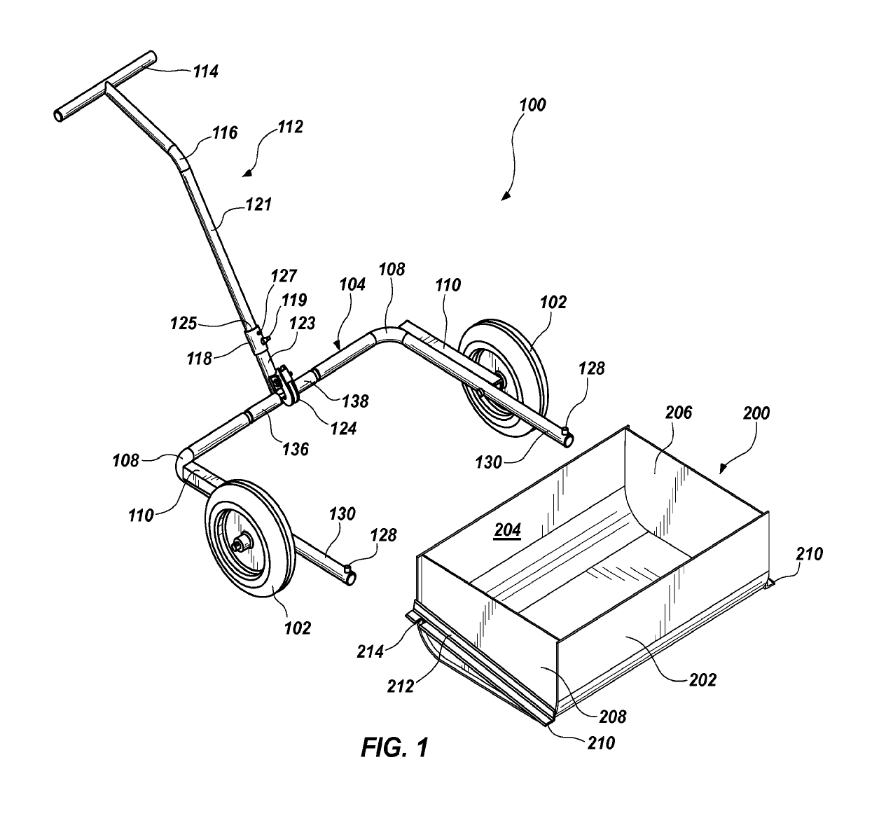

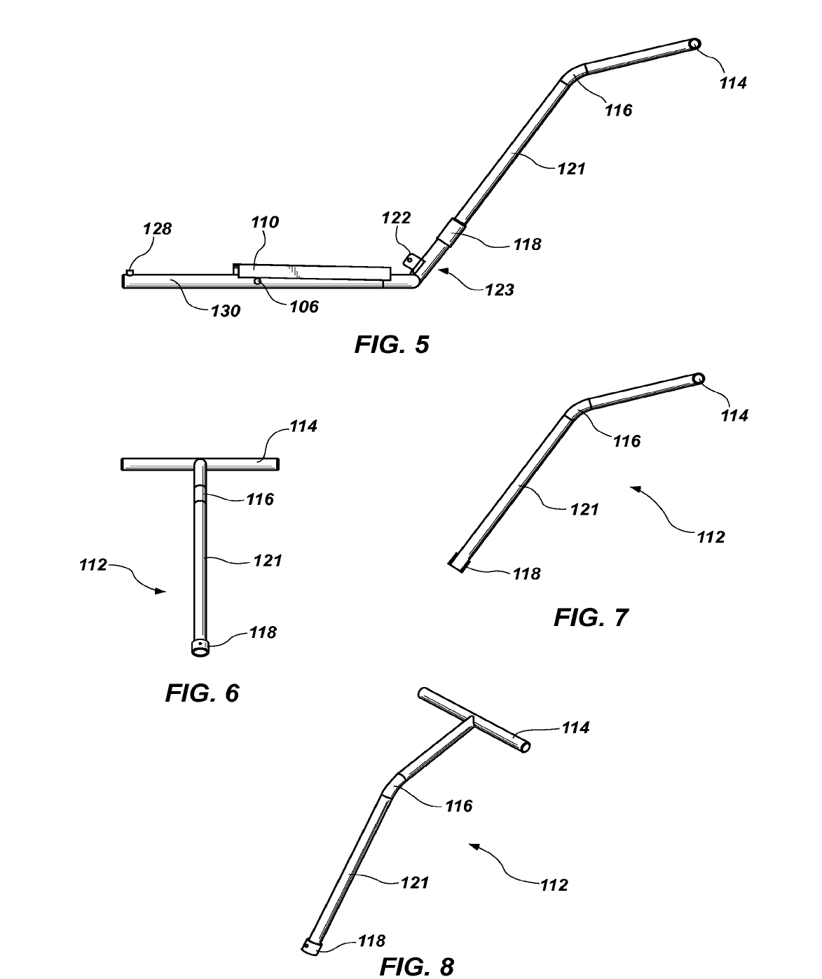

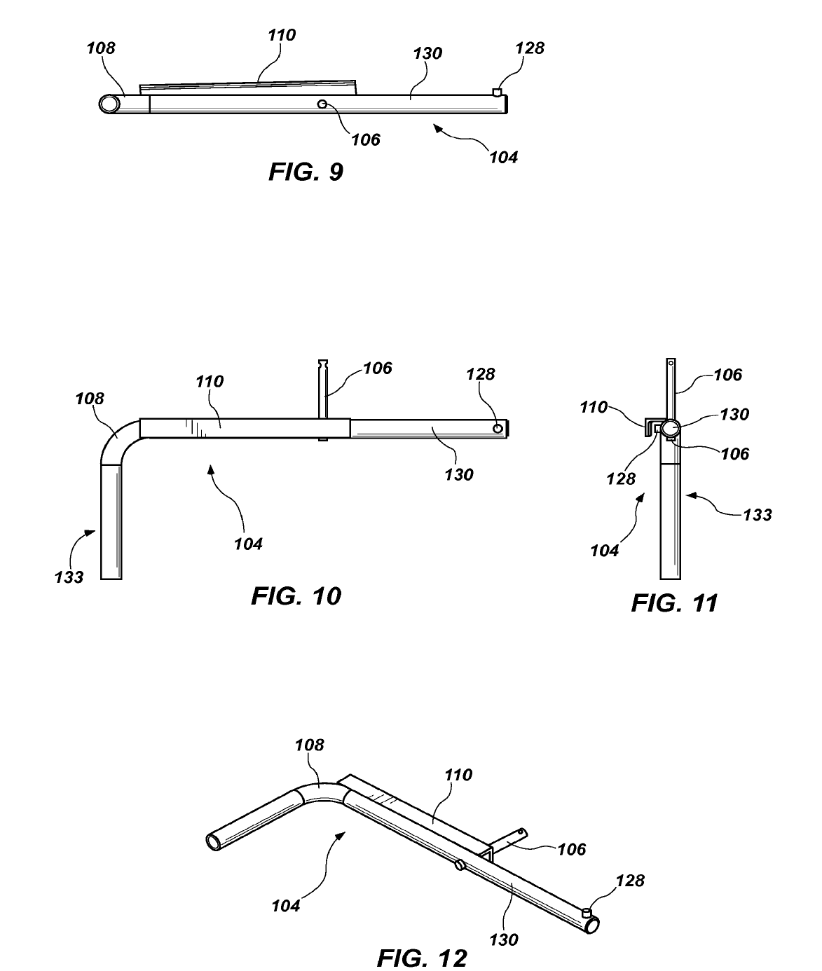

Referring now to FIGS. 1-5 and 9-12, the present invention in its various embodiments is a transport device 100. The transport device 100 includes a frame 104. The frame 104 can include one or more wheels 102 rotatably connected to axes 106. In the present embodiments, there is one wheel 102 on each side. However, in certain embodiments, it may be desirable to include multiple wheels on each side. In yet other embodiments, other rolling mechanisms that would be apparent to one skilled in the art could be utilized including, but not limited to tracks.

Suitable wheels for use with the present invention include, but are not limited to, 13 inch wheels with 0.625 inch hubs available from Marathon Industries, Inc. (Kent, Wash.).

In the present embodiments, the frame 104 is stainless steel tubing, but in other embodiments the frame could be numerous other materials that would be apparent to one skilled in the art including but not limited to iron; aluminum; combinations and alloys thereof; wood; plastics; and fiberglass and combinations thereof. It is also noted that the frame in this or other embodiments need not necessarily be tubing. This provides lighter weight and strength, but in certain embodiments, it may be desirable to have the frame made of a solid material. In other embodiments, it may be advantageous to have the frame, or portions thereof, have different cross-sectional shapes (other than substantially circular). Frame 104 is bent to substantially 90 degree angles at corners 108. This could be accomplished with 90 degree joints or bending a single piece.

Frame 104 includes at least two arms 130 that, as described further below, engage the bucket 200 at track 210. Near the ends of the arms 130, catchers 128 can be included. As is discussed further below, the catchers 128 can be used to pull the bucket 200—especially when full—to a more accessible location for loading onto the frame 104. The frame 104 can also include guide pieces 110 that help direct the placement of the bucket 200 and help secure bucket track 210 to arms 130 when in use—particularly when dumping. In certain embodiments, it may be advantageous to secure the guide pieces 110 to the bucket 200 rather than to the frame. In yet other embodiments, it may be advantageous to remove the guide pieces 110 altogether. The guide pieces 110 can be made of numerous materials that would be apparent to one skilled in the art including, but not limited to, steel, iron, aluminum and combinations and alloys thereof.

The transport device 100 also includes a handle assembly 112. Referring more particularly to FIGS. 6-8, the handle assembly 112 in the present embodiments is stainless steel tubing, but in other embodiments, the handle assembly could be numerous other materials that would be apparent to one skilled in the art including but not limited to iron; aluminum; combinations and alloys thereof; wood; plastics; and fiberglass and combinations thereof. Again, as noted in connection with the frame, the handle assembly need not necessarily be tubing. While such a configuration provides lighter weight and strength, in certain embodiments, it may be desirable to have the handle assembly made of a solid material. In other embodiments, it may be advantageous to have the assembly, or portions thereof, have different cross-sectional shapes (other than substantially circular).

Handle assembly 112 can include a handle portion 114 which in the present embodiments is a T-shape that can be equipped with grips or other similar mechanisms to improve grip and/or comfort. Handle assembly 112 can include a bend 116 and extension 121. The bend 116 and extension 121 helps the user provide more leverage in driving the device 100 forward, as well as tipping to engage and unload the bucket 200. It also provides greater comfort and control in turning—especially in embodiments having a rotating handle assembly (FIG. 38).

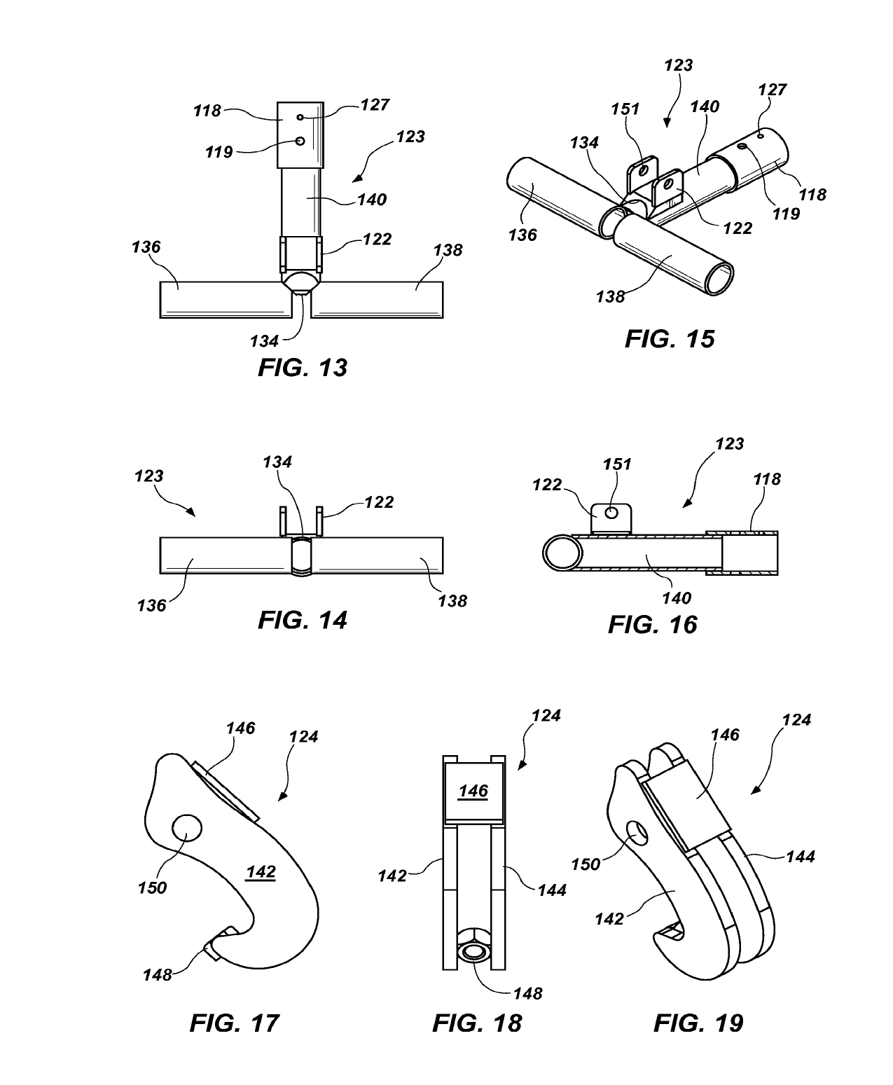

The transport device 100 also includes a latching assembly. Referring now more particularly to FIGS. 13-21, latch assembly 123 can include two base pieces 136, 138—which in this embodiment are stainless steel tubing—connected at substantially 90 degree angles to a connection piece 140. In this embodiment, the base pieces 136, 138 and the connection piece 140 are welded together. However, it is noted that numerous other mechanisms could be used to secure the pieces 136, 138, 140 together in a manner that would be suitable for use with the present invention. It is also noted that in some embodiments, the three pieces 136, 138, 140 could be molded as a single piece.

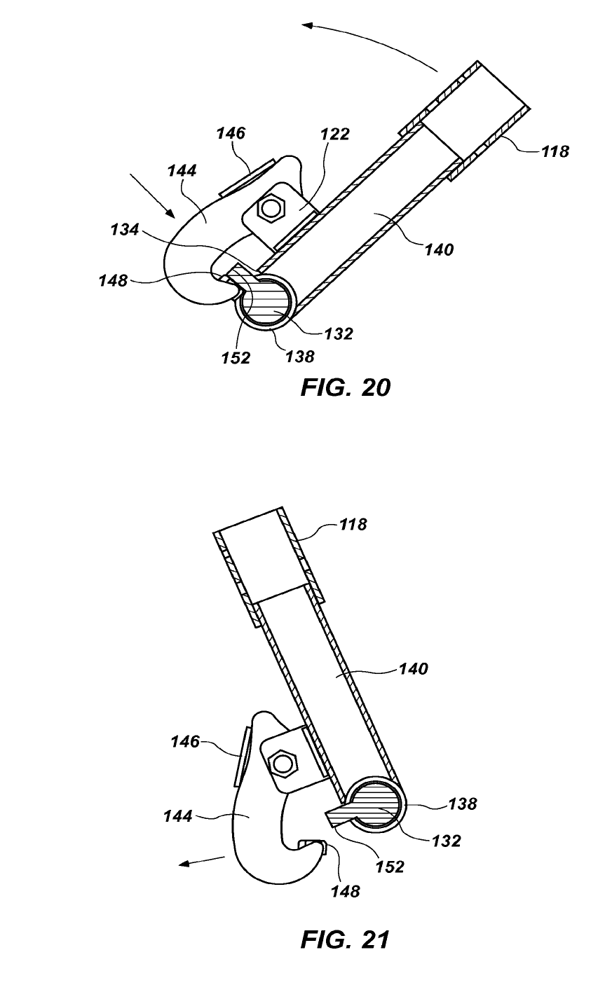

Fastener 122—which in the present case is a u-shaped fastener—is secured to connection piece 140. Fastener 122 is equipped with holes 151 corresponding to holes 150 in the hook latch 124. Thus, with a nut and bolt, or numerous other mechanisms that would be apparent to one skilled in the art, the hook latch 124 is coupled to the fastener 122 in a manner that allows it to rotate and thereby engage and disengage latching post 152 (FIGS. 20-21).

As best seen in FIGS. 17-19, the hook latch 124 can include two side pieces 142, 144 separated by spacer 146—which also serves to protect hook latch 124 from damage. In one embodiment, a threaded receptacle, such as a tightening nut 148, can be included between the side pieces 142, 144. As will become more evident below, the tightening nut 148 is advantageous in that it allows the longevity of the transport device 100 to be increased. Specifically, by inserting a bolt into the tightening nut (and adjusting as needed), the hook latch 124 is able to effectively grasp as the latching post 152 even as the post 152 wears down over time.

It is noted that hook latch 124 is shown in the present embodiments as two substantially parallel side pieces 142, 144. However, in other embodiments, the hook latch could be a single piece.

As best seen in FIGS. 20-21, when the handle assembly 112 is pushed forward, hook latch 124 slips over the latching post 152—which as noted below is secured to the back bar 133 of frame 104 and thus, the arms 130. When the handle assembly 112 is gently pulled back, the hook engages the post 152, which in turn pulls the arms 130 in an upward direction.

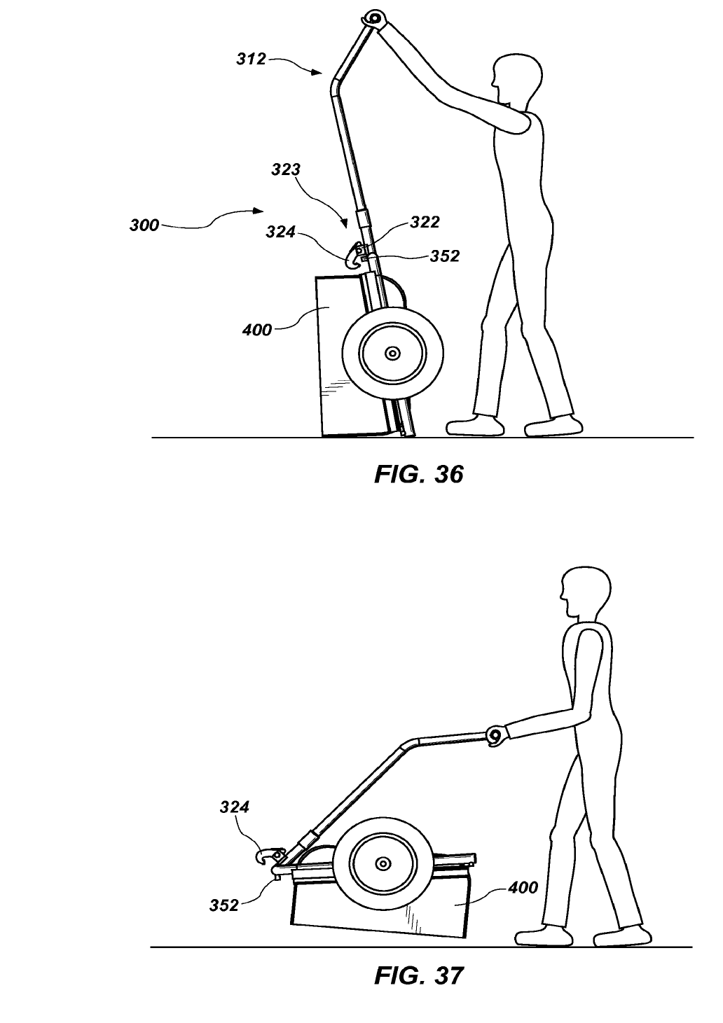

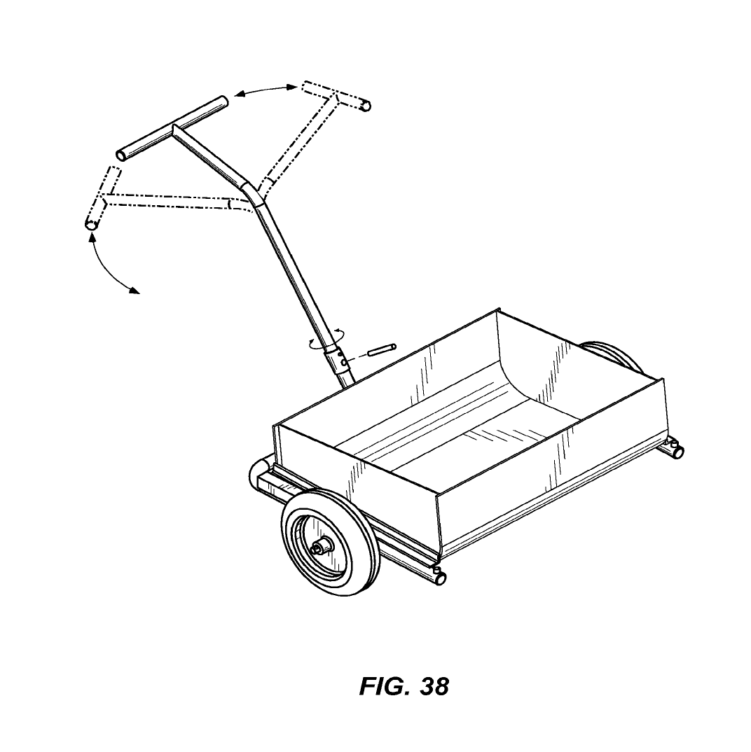

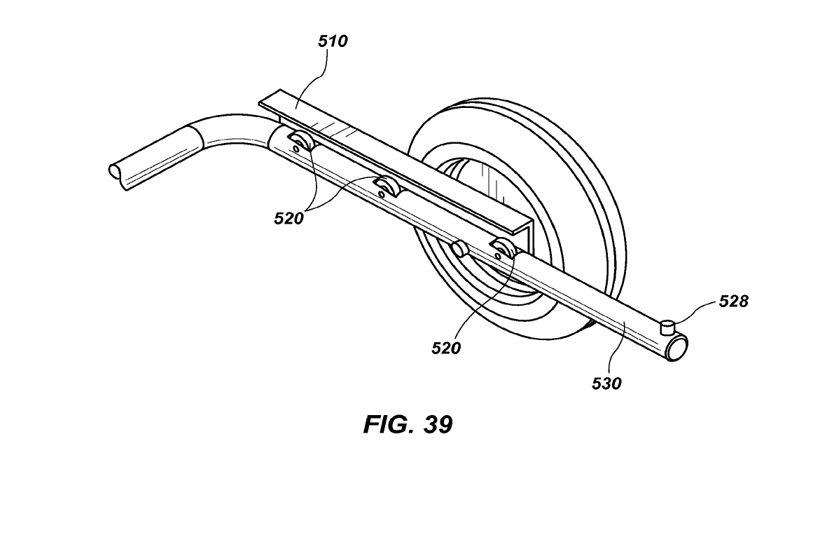

When the handle assembly 112 is pushed upward and forward, as when emptying the bucket 200, the bottom edge 134 of connection piece 140 rotates forward until it substantially abuts latching post 152. This allows the hook latch 124 to disengage from the hooking post 152 and swing forward. As depicted in FIGS. 36 and 37, handle assembly can then be pulled back and used to tip bucket (400 in FIGS. 36-37) until substantially upside down.

In the present embodiments, the latching assembly 123 connects to handle assembly 112 at sleeve 118. In certain embodiments, sleeve 118 can be used to both secure the handle assembly 112 to the latch assembly 123, and also to allow pivoting the handle assembly 112 in a variety of orientations (FIG. 38).

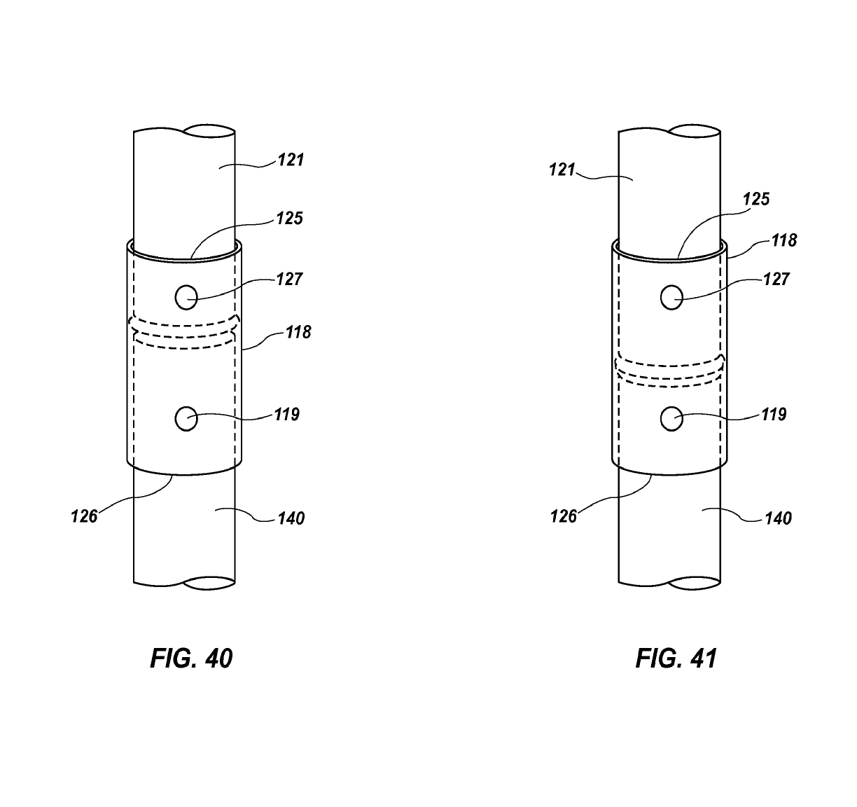

For example, FIG. 40 illustrates one locking/pivoting mechanism that could be used in connection with the present device. The bottom edge of the handle piece 121 is fashioned to have a slightly larger external diameter—giving it a slight bulge on the end. This increase in external diameter could be accomplished by numerous mechanisms that would be apparent to one skilled in the art including, but not limited to, welds, hardware, etc. The end of the handle piece 121 could then be inserted into sleeve 118. Afterward, the top edge of sleeve 125 could be fashioned to decrease its internal diameter. Again, numerous mechanisms for doing so would be apparent to one skilled in the art including, but not limited to, welds, hardware, etc.

By tightening or otherwise securing fastening mechanism 127—which in one embodiment is a screw or pin—the rotational movement of handle piece 121 can be substantially stopped. In like manner, by loosening the fastening mechanism 127, the handle piece 121 is able to rotate freely within the sleeve, but not fall out. Sleeve 118 is also connected to the connection piece 140 of the latch assembly 123 with fastening mechanism 119—which in one embodiment is a screw or pin. By loosening or removing fastening mechanism 119, the handle assembly 112 can be completely removed (e.g. for storage or transportation).

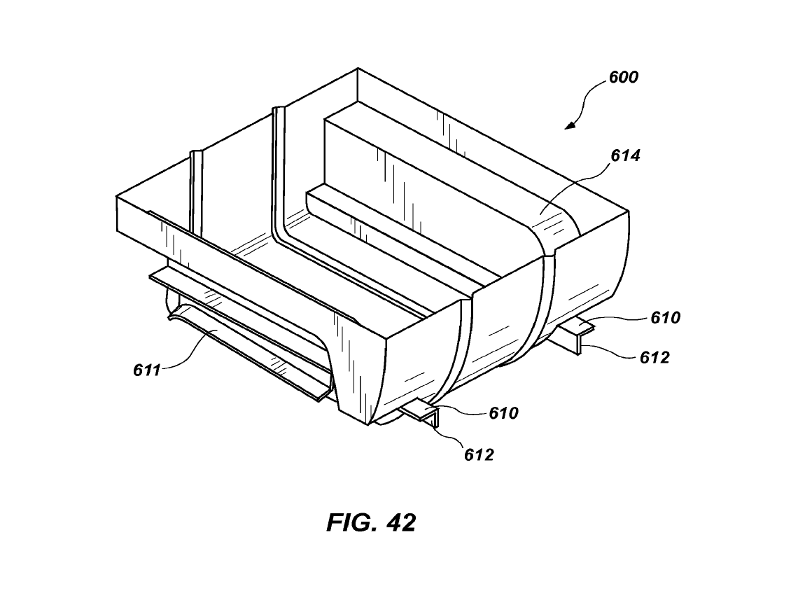

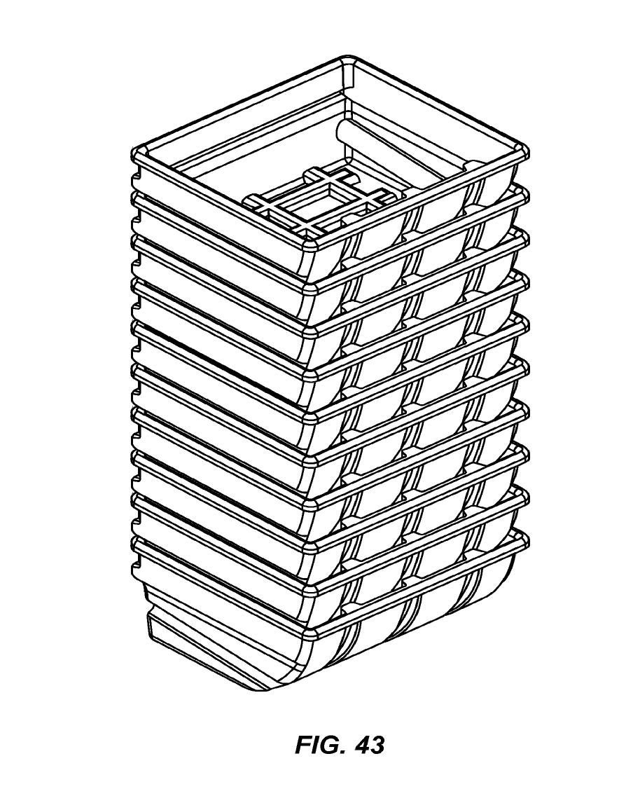

The rotational movement of the handle assembly could also be accomplished by having the pivot point on the connection piece 140 of the latch assembly 123. For example, as seen in FIG. 41, the top edge of the connection piece 140 could be fashioned to have the bulge—e.g. a larger external diameter on its top edge. This increase in external diameter could likewise be accomplished by numerous mechanisms that would be apparent to one skilled in the art including, but not limited to, welds, hardware, etc.

The end of the connection piece 140 could then be inserted into sleeve 118. Afterward, the bottom edge of sleeve 126 could be fashioned to decrease its internal diameter. Again, numerous mechanisms for doing so would be apparent to one skilled in the art including, but not limited to, welds, hardware, etc. By tightening or otherwise securing fastening mechanism 119, the rotational movement of the handle assembly 112 can be substantially stopped. In like manner, by loosening the fastening mechanism 119, the connection piece 140 is able to rotate freely within the sleeve, but not fall out—which rotation is transferred to the handle assembly 112. In such an embodiment, the handle piece 121 would be non-rotatably attached to sleeve at 127.

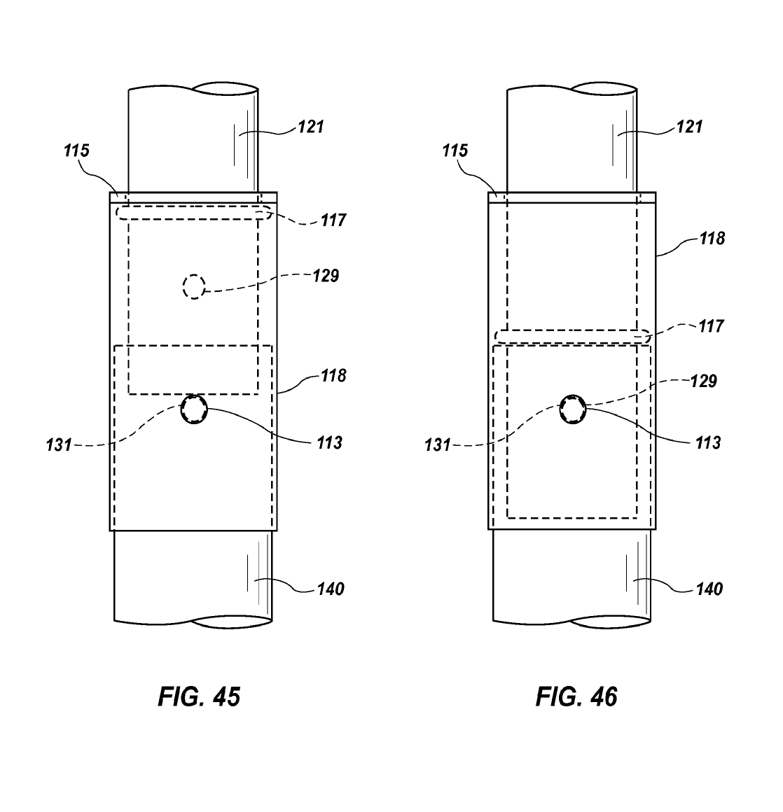

Of course, it is noted, that in some embodiments, it may be desirable to have rotational mechanisms on both the handle piece 121 and the latch piece 123. In yet other embodiments, it may be desirable to remove the rotational mechanism features altogether. In FIGS. 45-46, a different handle locking mechanism is shown according to one embodiment of the present invention. In this embodiment, there is again a handle piece 121, a connection piece 140 and a sleeve 118. Handle piece 121 has an exterior diameter that is smaller than the interior diameter of connection piece 140. The exterior diameter of connection piece 140 is smaller than interior diameter of sleeve 118. Thus, handle piece 121, connection piece 140 and sleeve 118 are capable of being telescopically expanded or collapsed. All three pieces include holes 129, 113, 131 into which a pin, bolt or other fastening mechanism can be inserted. As can be seen in FIG. 45, handle piece 121 is equipped with an external diameter expander 117—which in this case is a welded ring, but the external diameter could be expanded in whole or in part with numerous other mechanisms that would be apparent to one skilled in the art including partial rings; hardware such as screws; etc. In this embodiment, the inside top edge 115 of sleeve is equipped with a diameter reducer 115. As with the diameter expander 117, in this case, it is a welded ring but could be reduced in whole or in part with numerous other mechanisms that would be apparent to one skilled in the art including partial rings; hardware; etc. When a user wishes to be able to rotate the handle piece 121, he would simply raise handle piece 121 so that its bottom edge is above holes 113, 131. A fastening mechanism such as a pin or bolt can then be inserted into holes 113, 131 securing connection piece to sleeve 118. In some embodiments, the bottom edge of handle piece 121 can rest on top of the fastening mechanism when in this configuration. Diameter expander 117 keeps handle piece 121 rotatably connected to sleeve 118. As seen in FIG. 46, when a rotating handle is not desired, one would remove the pin of other fastening mechanism from holes 131, 113. Handle piece 121 could then slide down until the diameter expander 117 is substantially flush with the top edge of connection piece 140. In such a configuration, all three holes 129, 113, 131 are aligned such that a pin, bolt or other fastening mechanism could be inserted.

The rotational movement of the handle assembly is advantageous in that it allows the transport device 100 to be easily moved in a relatively small space. Specifically, rotating the handle assembly 112 allows maneuverability comparable to that found in one-wheeled transport devices but does so with much greater stability and balance.

The base pieces 136 and 138 of latching assembly 123 engage the back bar 133 of frame 104 and in this manner connect the latching assembly 123 to the frame 104. Specifically, in the present embodiments, the back bar 133 of frame 104 has a smaller exterior diameter relative to the interior diameter of the base pieces 136, 138. This allows the latching assembly 123, when attached, to rotate around the back bar 133.

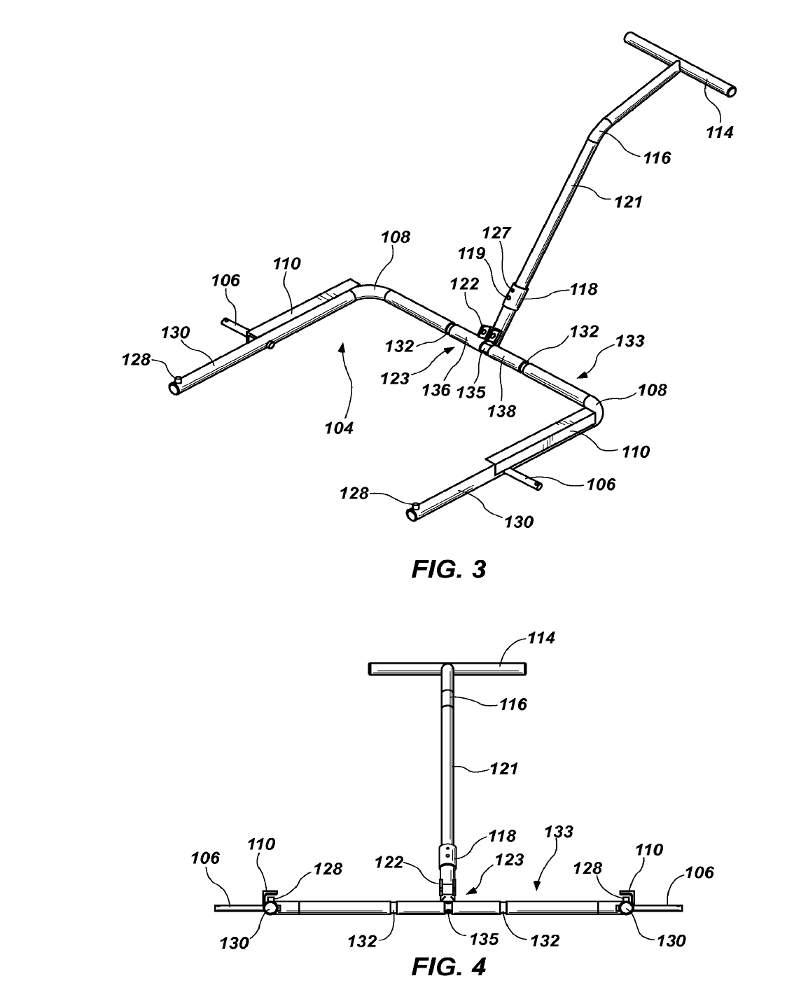

This rotatability can be accomplished in several ways. For example, as best seen in FIGS. 3 and 4, the back bar 133 can be segmented where a piece of cylindrical steel 132 having an exterior diameter that is slightly smaller than the interior diameter of the base pieces 136, 138 is inserted through the channels created by base pieces 136, 138. The ends of the cylindrical steel piece 132 are then inserted into right and left side pieces of the frame and secured (so they do not rotate). The securing of the cylindrical steel 132 into the frame pieces could be accomplished by numerous mechanisms that would be apparent to one skilled in the art including, but not limited to, welding and hardware.

Once the latching assembly 123 has engaged the back bar 133 of the frame 104, a latching post 152 (FIGS. 20 and 21) can be attached at 135. The latching post 152 in the present embodiments is affixed to the smaller diameter piece 132 of the back bar 133. It is noted that the latching post 152 is shown as a cylindrical shape but need not be. It could be planar; columnar; or countless other shapes that could engage the hook latch 124 as would be apparent to one skilled in the art.

The transport device 100 also includes a removable bucket 200. It is noted that the term “bucket” is not intended to be limited to any particular shape and is intended to include numerous configurations of a defined enclosure. In some embodiments, the buckets 200 have a substantially rectangular profile; in others, the profile is substantially square; in some, the bottom is rounded on both sides; in others the bottom is rounded on only a single side.

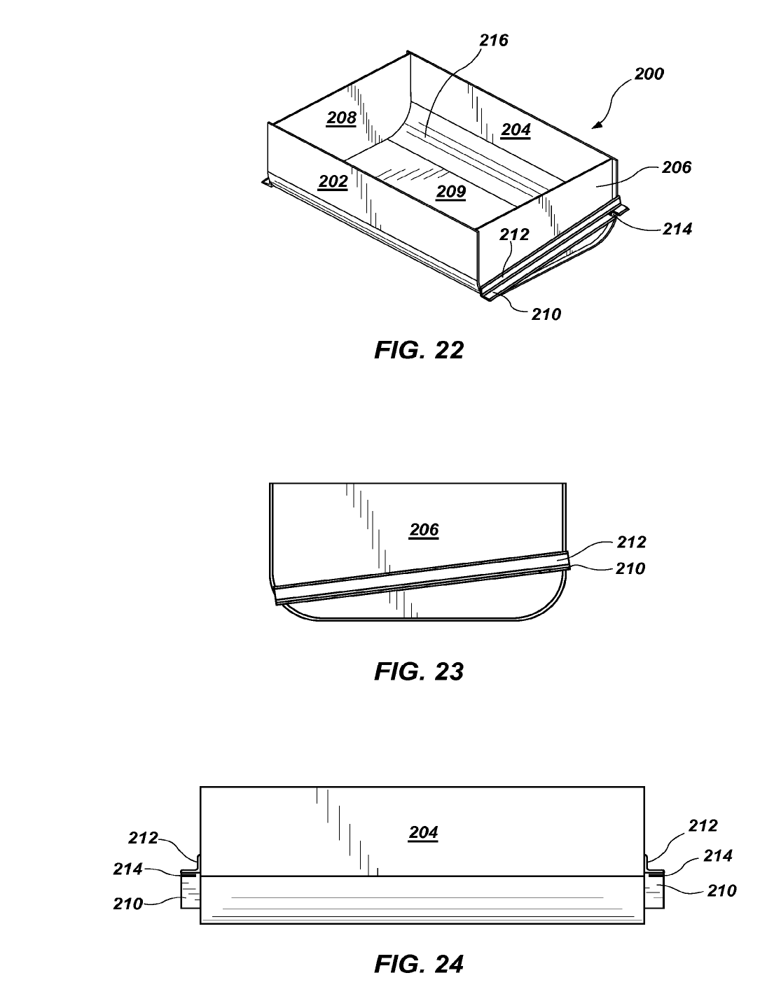

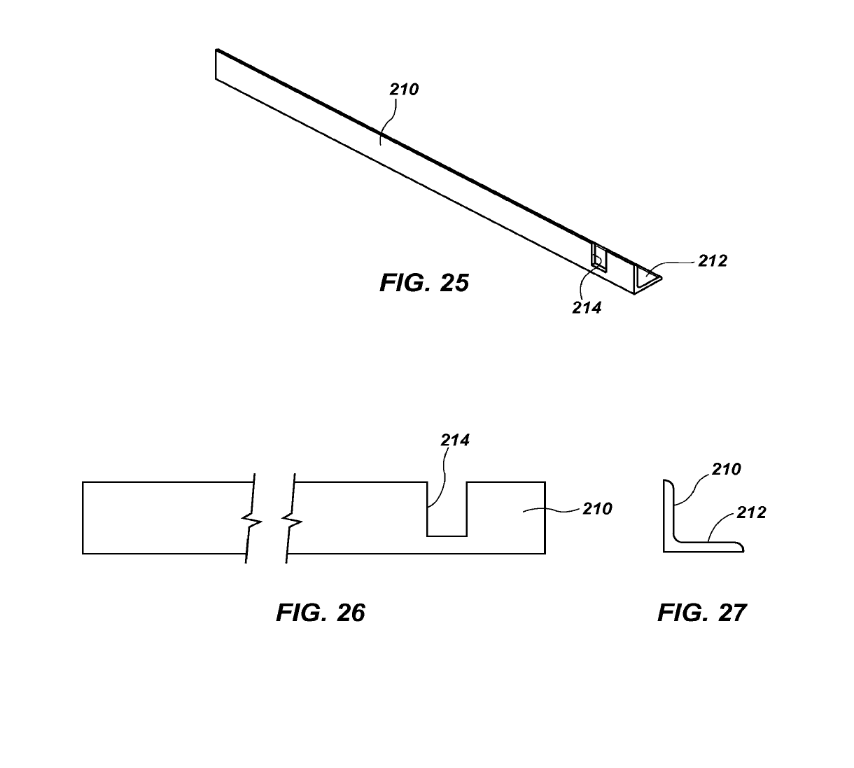

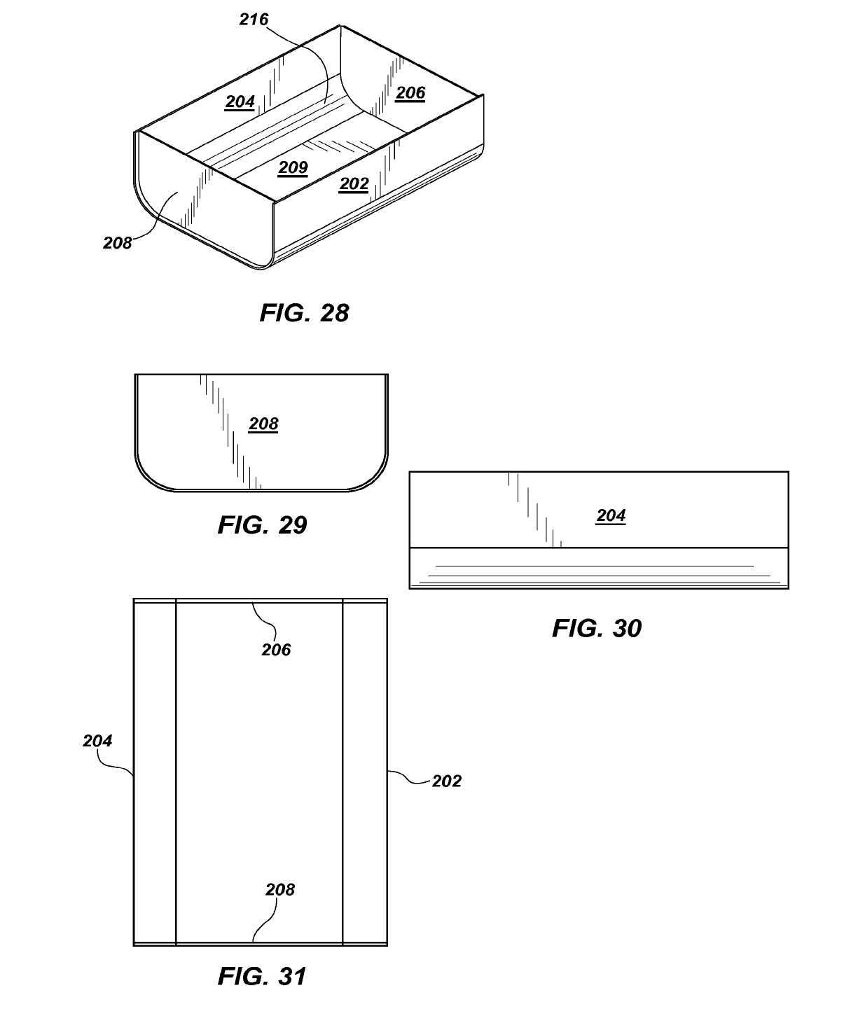

Referring now to FIGS. 1-2 and 22-31, the bucket 200 is generally characterized by an enclosure defined by four walls 202, 204, 206, 208 and a bottom 209. The bucket 200 includes a track mechanism 210 affixed to its sides. In one embodiment, the track 210 includes a vertical element 212 that is used to attach the track 210 to the side of the bucket 200. As best seen in FIGS. 25-27, the track 210 and vertical element can be a single L-shaped piece of steel. In other embodiments, the track 210 could be created by aligning multiple smaller pieces. Sometimes the smaller track pieces could be immediately adjacent to one another; in some instances, it may be desirable to have gaps between the track pieces.

The track 210 can include one or more notches 214 that are capable of being engaged by catchers 128 on the arms 130 of frame 104. In the present embodiments, the notches 214 are small cuts into the track 210. However, it is noted that in other embodiments, the track 210 could be engaged by catchers 128 in numerous other ways. For example, the catchers 128 could be recesses in the arms 130 and the track 210 could include a protrusion, such as a post, that is capable of being engaged by the catchers 128. In yet other embodiments, the catchers could be hooks substantially on the end tips of the arms 130 that are able to engage the bucket 200. In yet other embodiments, there could be hooking mechanisms on the bucket 200 and corresponding loops or other engagement mechanisms on the arms 130.

The track 210 in the presently described embodiments is angled such that it slopes toward the front of the bucket 200. This allows a user to more easily place the arms 130 underneath the track and thereby engage the bucket 200. It also allows for the bucket 200 and contents thereof to remain more level when the bucket 200 is lifted—thus minimizing spillage. However, it is noted that in some embodiments, it may be desirable for the track 210 to be substantially parallel to the bottom of the bucket 200.

It is also noted that in certain embodiments the bottom front of the bucket 200 can be Rounded—which, as noted above, allows for easier emptying. In other embodiments, the bucket can be rounded on the rear side 216 to allow for easier tipping when transporting. In other embodiments, it may be desirable to have rounded corners on both the front and rear of the bucket 200.

FIG. 42 shows a bucket configuration having wheel wells 614. This feature is advantageous in that it helps keep the wheels and axle debris free. For example, if the bucket is placed at the end of a conveyor belt, any over-filling can cause materials to spill out onto the wheels and axles. The wheel-wells provide a barrier to such spillage. It is also noted that in some instances, it is desirable to align several buckets side by side for filling. By utilizing the wheel-well bucket configuration, maneuvering the arms under the track 610 can be done—even when there is little or no space on the sides of the bucket 600. As mentioned above, it is also noted that in this particular embodiment, the guide pieces 611 are affixed to the bucket 600 rather than on the frame. It is also noted that in this embodiment, the track 610 is secured to the bucket with vertical pieces 612, though it is noted that in this embodiment the relative orientation of track 610 and vertical pieces 612 is inverted.

FIG. 43 shows a bucket configuration that is stackable according to one embodiment of the present invention. One advantage of having a removable bucket is that it allows a user to have multiple buckets and a single conveying mechanism (i.e. the frame/latch/handle assemblies). When not in use, the buckets could be stacked and stored occupying a comparatively small storage space.

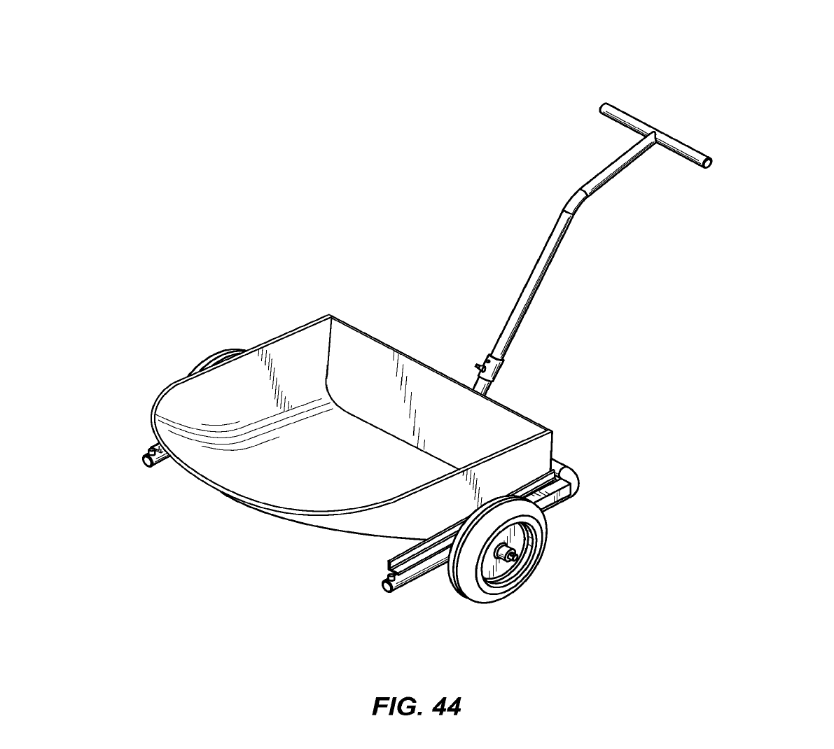

FIG. 44 shows yet another bucket configuration having a more conventional wheelbarrow front pouring edge.

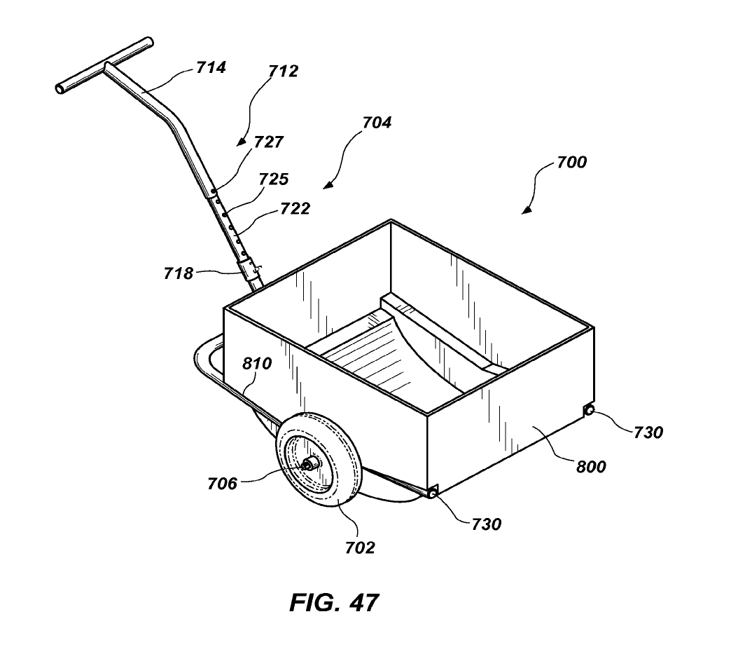

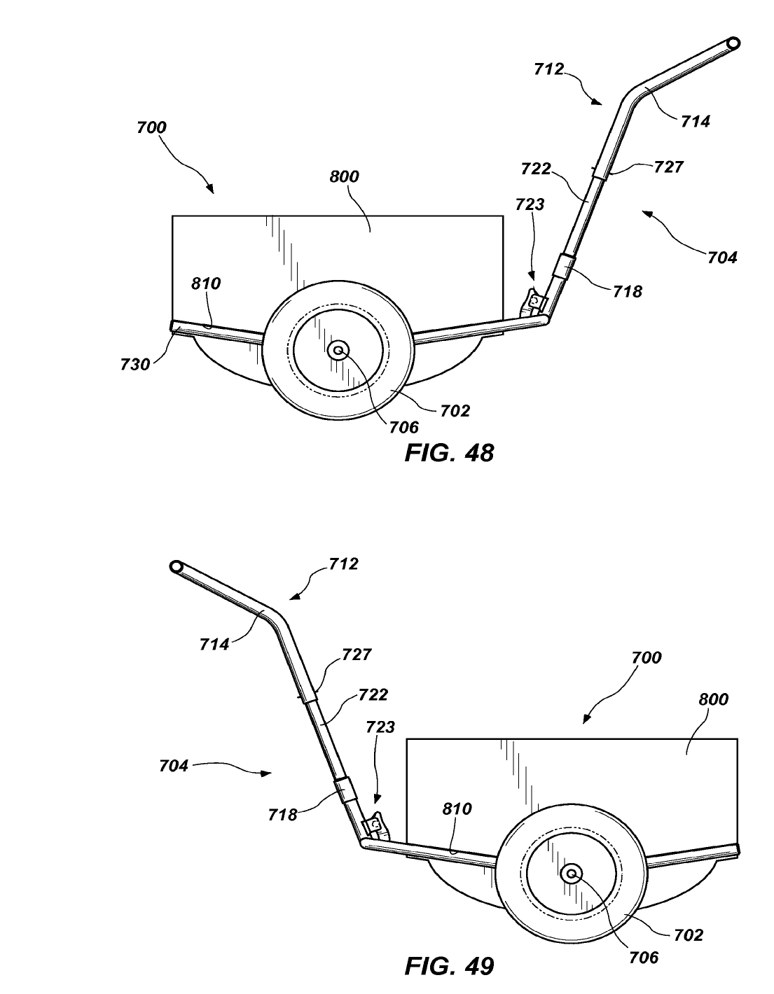

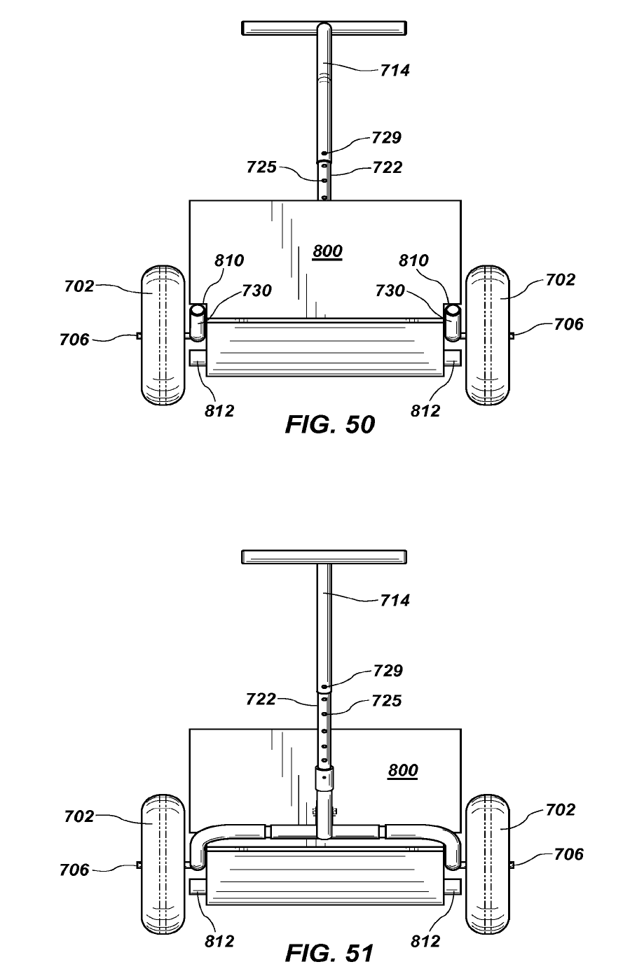

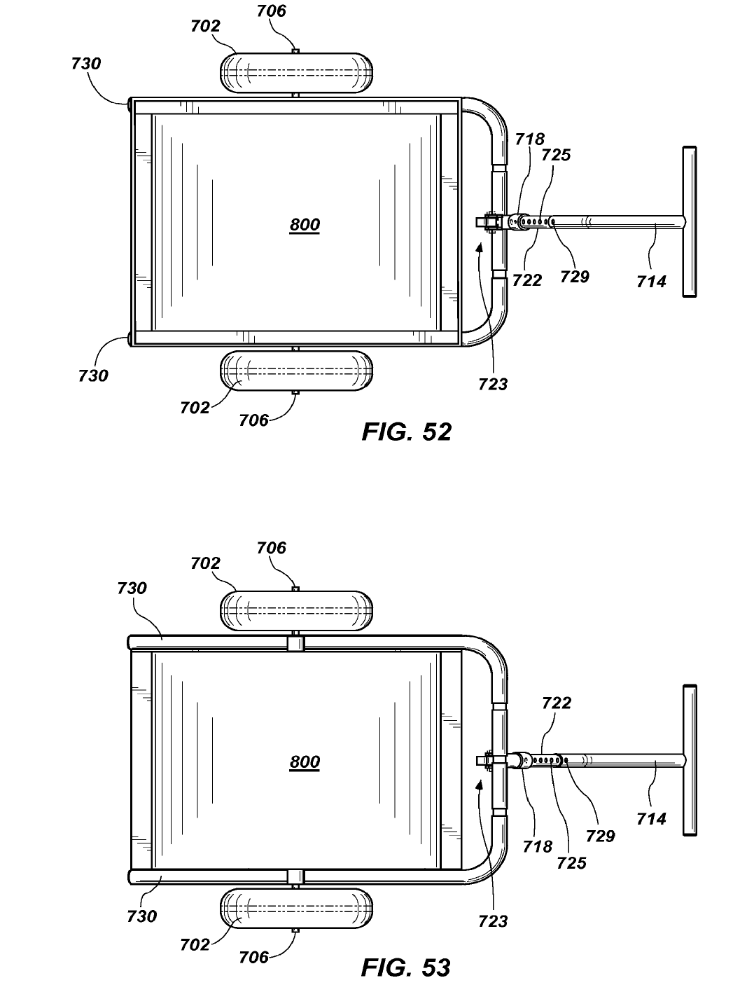

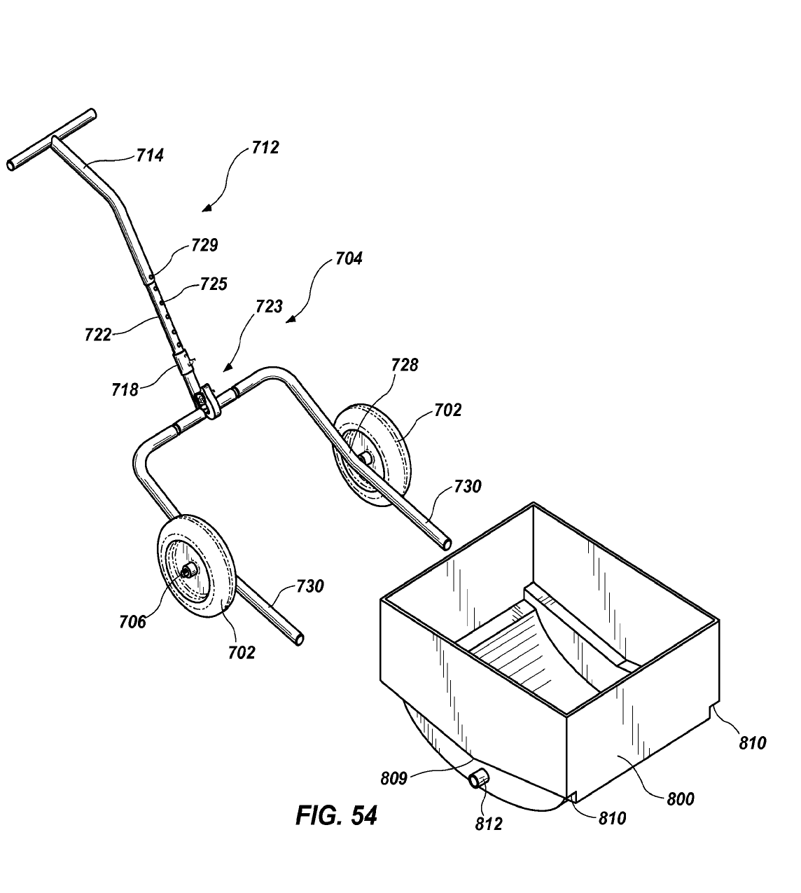

FIGS. 47-56, show yet another embodiment of a transport device 700 having many similar or identical features to those discussed above including, but not limited to, a removable bucket 800 having tracks 810 on the outside surfaces; a frame assembly 704 having one or more arms 730 corresponding to and capable of engaging the tracks; one or more movement mechanisms 702 such as wheels coupled to the frame assembly 704; a latching assembly 723 rotatably coupled to the frame assembly 704; and a handle assembly 712 coupled to the latching assembly 723.

However, in the present embodiment, the frame assembly 704 includes bends 728 in the arms 730. In this embodiment, the bends 728 are proximate the axles 706 to which wheels 702 are secured. However, in other embodiments, the bends 728 could be at other locations on the arms 730. These bends 728 correspond to tracks 810 on bucket 800. In this embodiment the track 810 is a substantially v-shaped overhang 809 created by a narrowing in the bottom of the bucket 800. In other embodiments, the track 810 could have other configurations that include, but are not limited to, substantially u-shaped, or multi-angular.

One or more posts 812 can also be included beneath the tracks 810. Posts 812 serve to guide the arms 730 as they engage the tracks 810. They can also provide leverage and help hold the bucket 800 in places when it is being tipped for dumping. The posts 812 shown in this embodiment are substantially circular in cross section having a length approximately the same as the width of the track 810. However, in other embodiments, the posts could be different cross-sectional shapes and different lengths.

As noted above bucket 800 can be in varying configurations. For example, the front of the bucket can be rounded—which, as noted above, allows for easier emptying. In other embodiments, the bucket can be rounded on the rear side to allow for easier backward tipping when transporting. In other embodiments, it may be desirable to have rounded corners on both the front and rear of the bucket.

These embodiments also illustrate a unique handle assembly 712. In particular, this embodiment includes a handle portion 714 that corresponds to an adjuster element 722 that is further coupled to the latching assembly 723 at sleeve 718. The adjuster element 722 has an exterior diameter that is slightly smaller than the inter diameter of the handle portion 714 and the sleeve 718. The handle portion 714 also includes one or more holes 729 that correspond to one or more holes 725 in the adjuster element 722. Thus, handle portion 714 can be telescopically slid over the adjuster element 722 depending on the desired height of the handle assembly 712. Once in the approximate desired location, the holes 729, 725 are aligned and a fastener 727 can be inserted through both to secure the handle assembly 712 in place. The fastener 727 can then be subsequently removed and the handle portion 714 repositioned as needed.

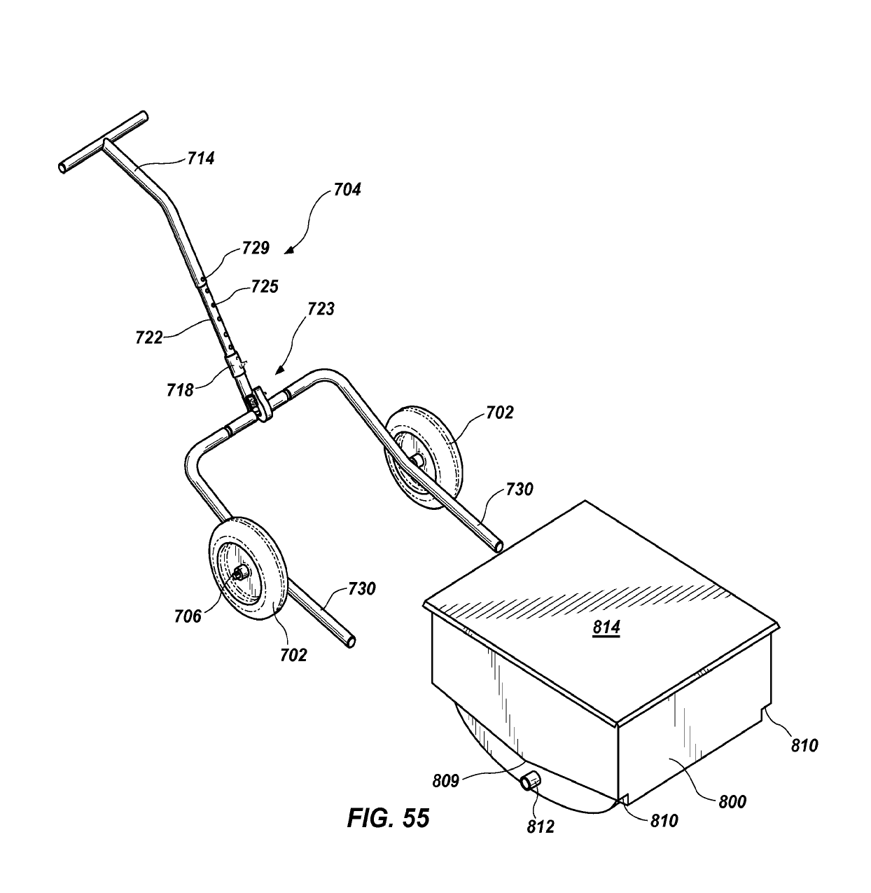

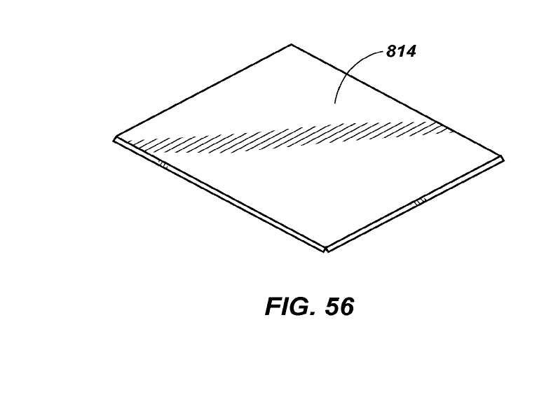

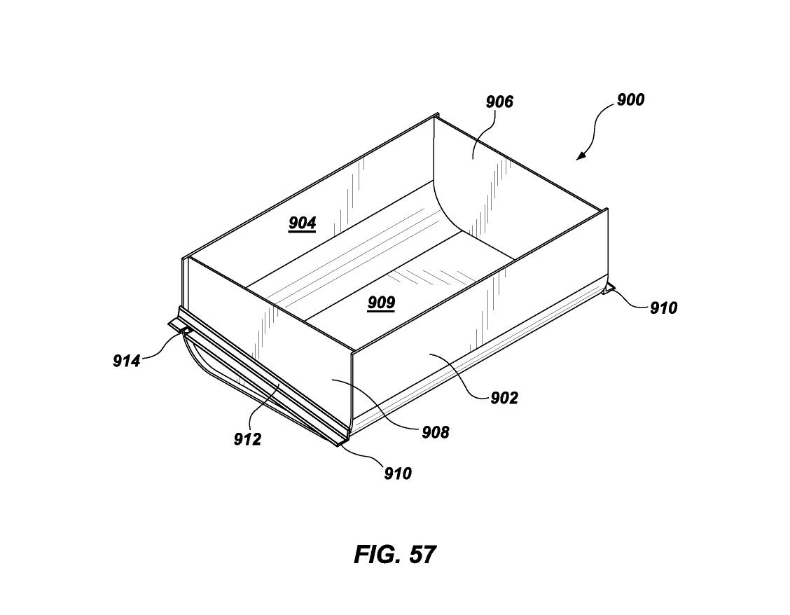

Advantageously, the handle portion 714 can be completely collapsed or even removed. Removal of the handle portion 714 allows easier storage and transportation of the device. Certain embodiments of the device allow bucket capacity equal to or greater than standard wheel barrows, but which can be transported in the trunk of an ordinary car. For example, in one embodiment, the wheels are secured to the axle with pin bolts, thus allowing for their easy removal. As such, a user could remove the handle portion and wheels and place them inside the bucket. The profile then becomes so small that the entire device can be easily fit into a relatively small storage space. As seen in FIGS. 55 and 56, the bucket 800 can also be equipped with a lid 814 to secure the items therein.

Frame 704 and handle assembly 712 are, in one embodiment, made of stainless steel tubing, but could be numerous other materials that would be apparent to one skilled in the art including but not limited to iron; aluminum; combinations and alloys thereof; wood; plastics; and fiberglass and combinations thereof. It is also noted that the frame 704 and handle assembly 712 need not necessarily be tubing. In certain embodiments, it may be desirable to have the frame 704 and handle 712 made of a solid material. In other embodiments, it may be advantageous to have the frame 704 and handle 712, or portions thereof, have different cross-sectional shapes (other than substantially circular). As noted in previous embodiments, the frame 704 in this embodiment is bent to substantially 90 degree angles at corners. This could be accomplished with 90 degree joints or bending a single piece.

Referring now to FIG. 57, a front perspective view of a removable bucket 900 is shown according to one embodiment of the present invention. The bucket 900 is generally characterized by an enclosure defined by four walls 902, 904, 906, 908 and a bottom 909. The bucket 900 includes a track mechanism 910 affixed to its sides. In this embodiment, the track 910 includes a vertical element 912 that is used to attach the track 910 to the side of the bucket 900. The track 910 and vertical element can be a single L-shaped piece of steel. In other embodiments, the track 910 could be created by aligning multiple smaller pieces. Sometimes the smaller track pieces could be immediately adjacent to one another; in some instances, it may be desirable to have gaps between the track pieces.

The track 910 can include one or more notches 914 that are capable of being engaged by catchers on the arms of the frame (as discussed previously). In the present embodiment, the notches 914 are small cuts into the track 910. However, it is noted that in other embodiments, the track 910 could be engaged by catchers in numerous other ways as previously discussed herein. The track 910 in the presently described embodiments is angled such that it slopes toward the front of the bucket 900. However, it is noted that in some embodiments, it may be desirable for the track 910 to be substantially parallel to the bottom of the bucket 900.

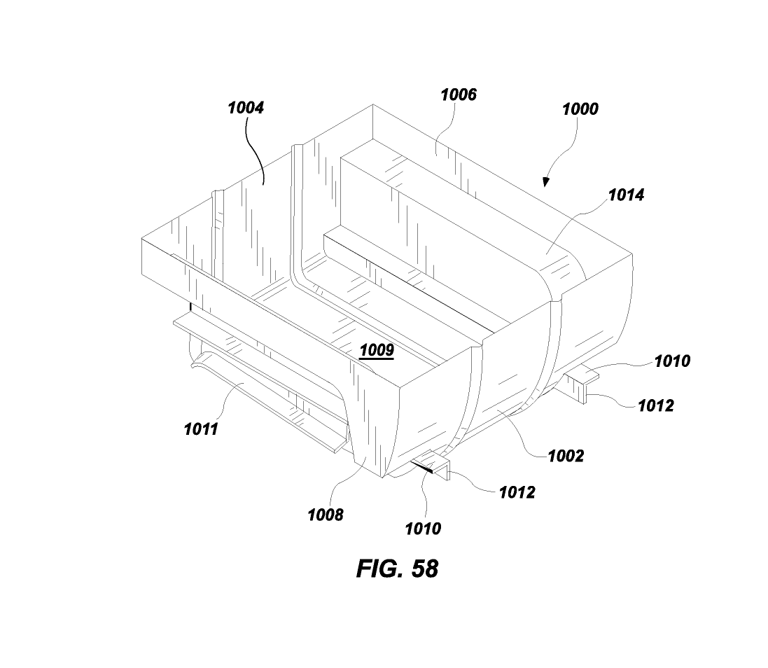

Referring now to FIG. 58, a front perspective view of a removable bucket 1000 is shown according to one embodiment of the present invention. The bucket 1000 is generally characterized by an enclosure defined by four walls 1002, 1004, 1006, 1008 and a bottom 1009. The bucket 1000 includes a track mechanism 1010 affixed to its sides. The track 1010 includes a vertical element 1012. Again, the track 1010 and vertical element can be a single L-shaped piece of steel. In other embodiments, the track 1010 could be created by aligning multiple smaller pieces. Sometimes the smaller track pieces could be immediately adjacent to one another; in some instances, it may be desirable to have gaps between the track pieces. This bucket configuration has wheel wells 1014. Guide pieces 1011 are also affixed to the bucket 1000.

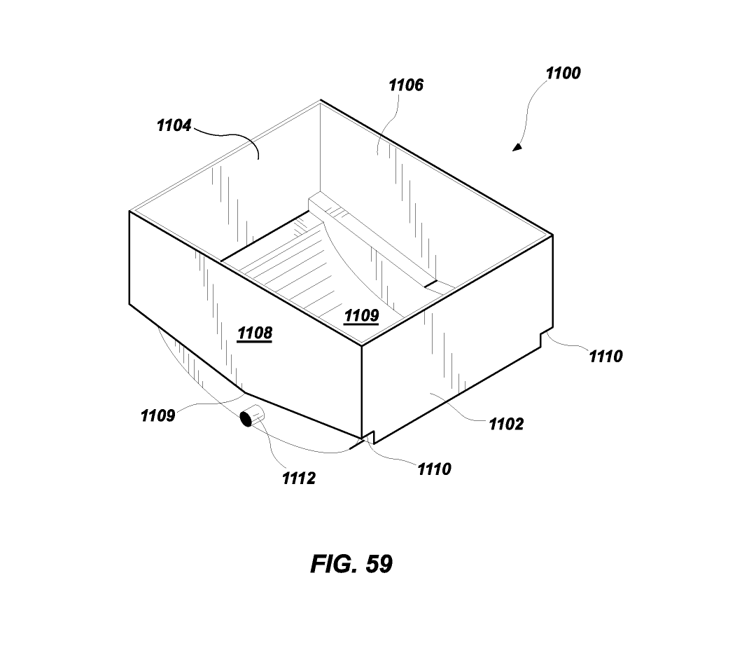

Referring now to FIG. 59, a front perspective view of a removable bucket 1100 is shown according to one embodiment of the present invention. The bucket 1100 is generally characterized by an enclosure defined by four walls 1102, 1104, 1106, 1108 and a bottom 1109. In this embodiment the track 1110 is a substantially v-shaped overhang 1109 created by a narrowing in the bottom of the bucket 1100. In other embodiments, the track 1110 could have other configurations that include, but are not limited to, substantially u-shaped, or multi-angular.

One or more posts 1112 can also be included beneath the tracks 1110. Posts 1112 serve to guide the frame assembly arms as they engage the tracks 1110. They can also provide leverage and help hold the bucket 1100 in places when it is being tipped for dumping. The posts 1112 shown in this embodiment are substantially circular in cross section having a length approximately the same as the width of the track 1110. However, in other embodiments, the posts could be different cross-sectional shapes and different lengths.

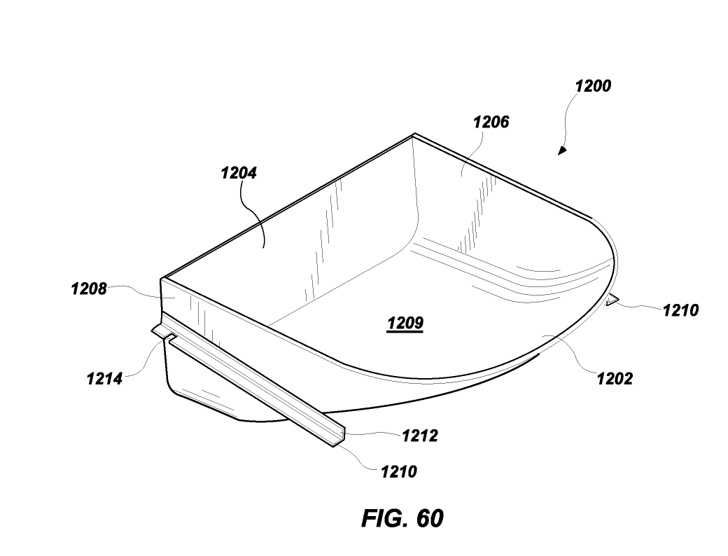

Referring now to FIG. 60, a front perspective view of a removable bucket 1200 is shown according to one embodiment of the present invention. The bucket 1200 is generally characterized by an enclosure defined by four walls 1202, 1204, 1206, 1208 and a bottom 1209. The bucket 1200 includes a track mechanism 1210 having a vertical element 1212 affixed to its sides. The track 1210 and vertical element can be a single L-shaped piece of steel. In other embodiments, the track 1210 could be created by aligning multiple smaller pieces. Sometimes the smaller track pieces could be immediately adjacent to one another; in some instances, it may be desirable to have gaps between the track pieces.

The track 1210 can include one or more notches 1214 that are capable of being engaged by catchers on the arms of the frame (as discussed previously). In the present embodiment, the notches 1214 are small cuts into the track 1210. However, it is noted that in other embodiments, the track 1210 could be engaged by catchers in numerous other ways as previously discussed herein. Wall 1202 in this embodiment has a more conventional wheelbarrow front pouring edge.

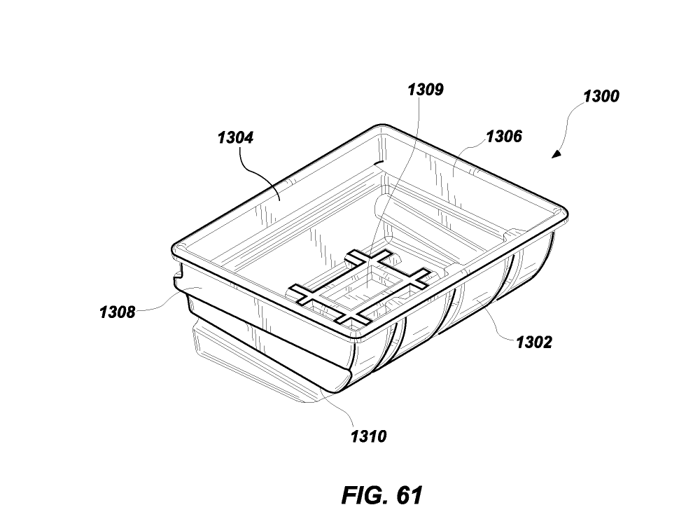

Referring now to FIG. 61, a front perspective view of a removable bucket 1300 is shown according to one embodiment of the present invention. The bucket 1300 is generally characterized by an enclosure defined by four walls 1302, 1304, 1306, 1308 and a bottom 1309. The bottom 1309 includes structural ribbing. The bucket 1300 includes an integrated track mechanism 1310. When not in use, the buckets 3100 can be stacked and stored occupying a comparatively small storage space.

Method of Operation

For purposes of better understanding the present invention, illustrative examples are provided. They are in no way intended to limit the scope of the present invention as defined in the claims.

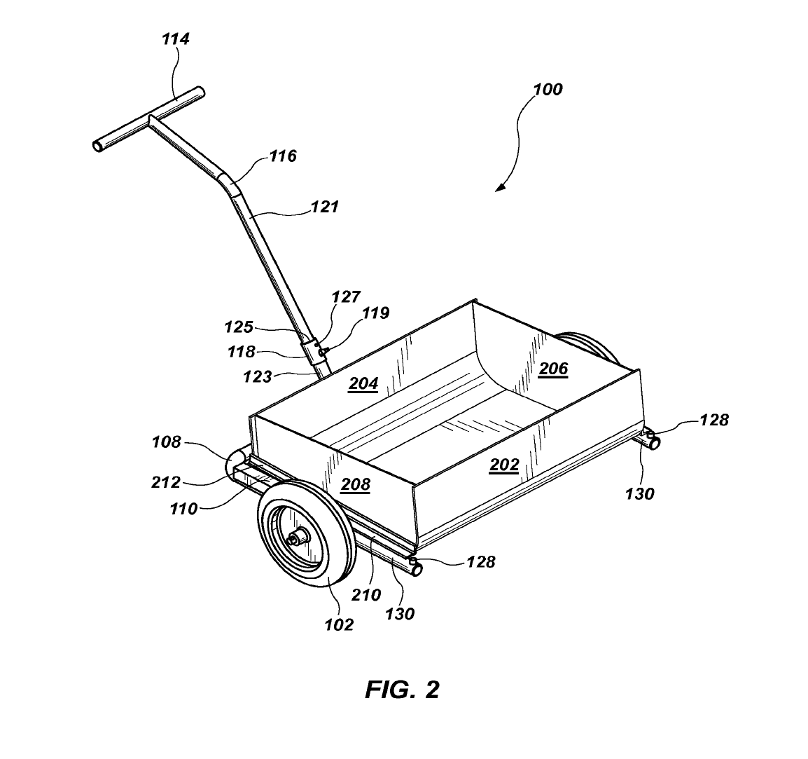

Referring to FIGS. 1-2, before engaging the bucket 200 on the frame 104—whether full or empty—its positioning may be less than ideal. As such, the arms 130 can be tilted downward and the catchers 128 can be placed under the notches 214. The handle assembly 112 can then be pushed down and the catchers 128 will rise up into and engage the notches 214. The bucket 200, once so engaged, can then be dragged out to a more desirable location.

Once the bucket 200 is placed where desired, a user would then disengage the catchers 128 from the notches 214 and slide arms 130 underneath tracks 210. The weight of the bucket 200—especially when filled—helps keep bucket 200 in place while the user pushes the handle assembly 112 in a substantially forward direction. The handle assembly 112 can then be pushed in a substantially downward direction. This will raise the bucket 200 off the ground and as the handle assembly 112 is pushed farther downward, the bucket 200 will slide fully into place and can then be transported where desired.

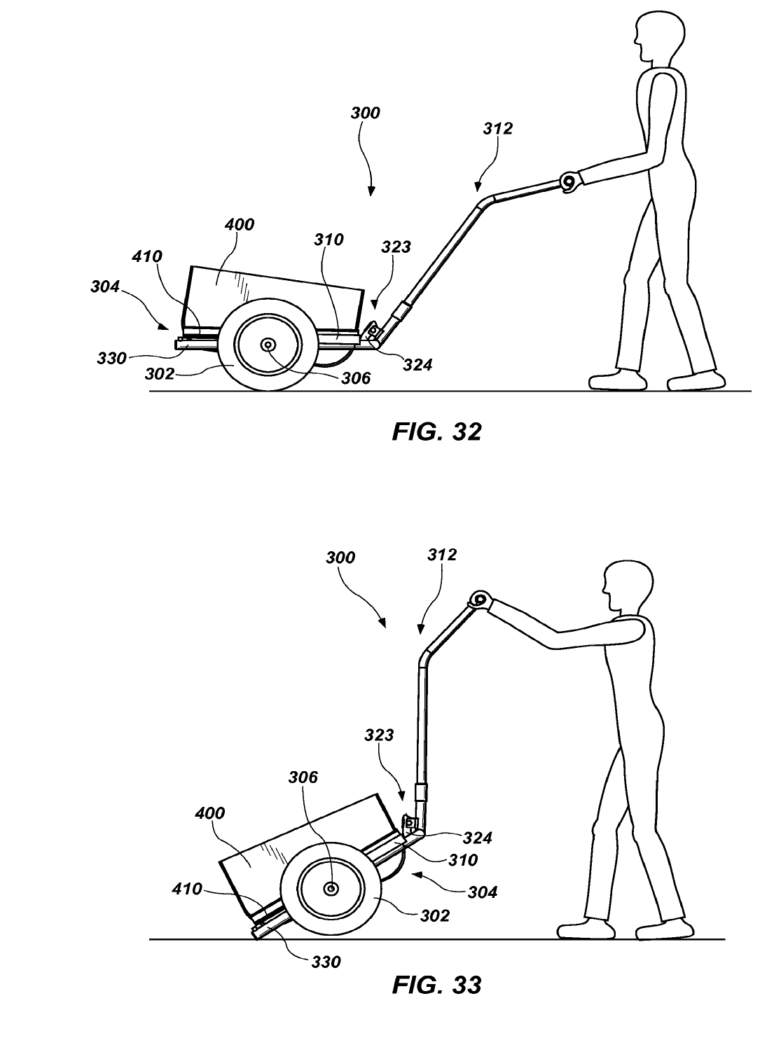

Referring now to FIGS. 32-37, the movement and emptying of a transport device 300, according to one embodiment of the present invention, is shown. This transport device 300 includes wheels 302 attached to a frame 304 at axes 306. The frame 304 includes guide pieces 310 on each of the arms 330 that direct the placement of the bucket 400 and help secure track 410. It is noted that in this case, the arms 330 extend beyond the front edge of bucket 400. This configuration allows the arms 330 to absorb some of the weight of the bucket contents when dumping—which helps preserve the integrity of the bucket 400. However, in other embodiments, it may be desirable to have shorter arms 330.

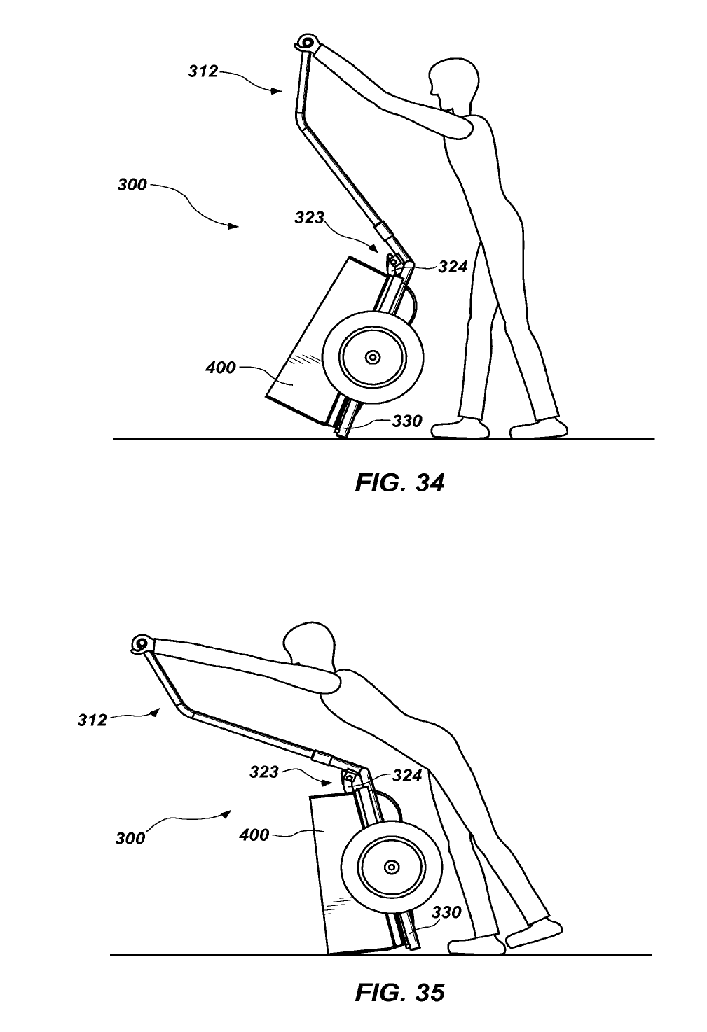

The user would push the handle assembly 312 which forward motion would move the bucket 400 and its contents to the desired location. As seen in FIGS. 33-34, once at the desired location, the user would push the handle assembly 312 in a forward and upward direction. The arms 330 create frictional resistance with the surface on which the bucket 400 is being dumped and the user pushing on the handle assembly 312 tips the bucket 400. As depicted in FIG. 35, once the bucket 400 has been pushed into a substantially upright position, the hooking latch 324 of the latching assembly 323 disengages from latching post 352 (FIGS. 36-37). As depicted in FIGS. 36-37, the handle assembly 312 can then be rotated back and used to push the bucket 400 into a substantially inverted position. It is noted that the hooking latch 324 is typically substantially free hanging. Thus, the depiction in FIG. 37 is for illustrative purposes to signify that the hook 324 has detached from post 352.

In certain embodiments, friction reduction features can be added to the transport device to facilitate sliding the bucket onto the conveyance mechanism. For example, as seen in FIG. 39, wheels 520 can be added to arms 530. In this embodiment, three wheels 520 are placed just below guide rail 510. Thus, when a bucket is slid onto the arms 530, the wheels 520 allow for a much smoother engagement between the arms 530 and the track. It is noted that in some embodiments, more or fewer wheels may be desirable. In other embodiments, the placement of the wheels can be altered. For example, in one embodiment, there is a single wheel substantially at the end of each arm. In yet other embodiments, the friction reduction feature could be on the bucket track. Other friction reduction features would be apparent to one skilled in the art including, but not limited to, ball bearings; lubricants; graphite or other carbon coatings.

Referring to the embodiments in FIGS. 47-56, a user would slide arms 730 underneath tracks 810 and push the handle assembly 712 in a substantially downward direction. This raises the bucket 800 off the ground and as the handle assembly 712 is pushed downward, the bucket 800 slides until the v-shaped overhang 809 engages the bends 728 in arms 730. The bucket 800 can then be transported where desired and dumped in a manner similar to that described in connection with the other embodiments discussed above.

It is understood that the above-described arrangements are only illustrative of the application of the basic principles of the present invention. Numerous modifications and alternative arrangements may be devised by those skilled in the art without departing from the spirit and scope of the present invention. The appended claims are intended to cover such modifications and arrangements.

For example, base pieces 136, 138 as discussed above, are shown to be substantially tubular. On the inside of pieces 136, 138, this is advantageous so the base pieces 136, 138 can rotate around back bar 133 of frame 104. However, the exterior of the base pieces 136, 138 could be numerous other shapes in cross section including but not limited to substantially square; substantially pentagonal; substantially hexagonal; etc.

It is also noted that in certain embodiments described above, base pieces 136, 138 and connection piece 140 are three separate pieces connected together with a weld, adhesive, mechanical means or other connection mechanism that would be apparent to one skilled in the art. However, in other embodiments, this feature could be single molded piece.

In the above-described embodiments, the back bar 133 includes a smaller diameter piece of frame 132—this is the axis along which latch piece 123 (as well as handle assembly 112 when engaged) rotates. This is advantageous as it keeps the latch piece 123 in substantially the same lateral position. However, it is noted that in some instances, it may be desirable to have the frame, or at least the back bar piece 133 be of substantially uniform in diameter or even other variations in diameter. The latch piece could easily be adjusted to accommodate such diameters and could be held in place by a variety of mechanisms that would be apparent to one skilled in the art.

1. A transport device removable bucket comprising:
a) a first, second, third and fourth wall defining an enclosure;
b) a first track on an outside surface of the first wall;
c) a second track on an outside surface of the second wall; wherein the first and second track correspond to one or more arms on a frame assembly.

2. The removable bucket of claim 1, wherein the first and second tracks are affixed to the first and second walls respectively.

3. The removable bucket of claim 1, wherein the first and second tracks are integrated with the first and second walls respectively.

4. The removable bucket of claim 2, wherein the first and second tracks include a first and second vertical element which attach the first and second tracks to the first and second wall respectively.

5. The removable bucket of claim 1, wherein the first and second tracks are overhangs created by a narrowing of a bottom portion of the removable bucket.

6. The removable bucket of claim 5, wherein the first and second tracks are substantially v-shaped.

7. The removable bucket of claim 1, wherein the first and second tracks include one or more notches that are capable of being engaged by catchers on the frame assembly.

8. The removable bucket of claim 1, wherein the first and second tracks are angled.

9. The removable bucket of claim 1, wherein the fourth wall is rounded for easier emptying.

10. The removable bucket of claim 1, wherein the third wall is rounded for easier tipping when transporting.

11. The removable bucket of claim 1, wherein the enclosure has one or more rounded corners.

12. The removable bucket of claim 1, further comprising one or more wheel wells.

13. The removable bucket of claim 1, further comprising one or more guide pieces.

14. The removable bucket of claim 1, wherein the bucket is stackable.

15. The removable bucket of claim 1, wherein the fourth wall includes a pouring edge.

16. The removable bucket of claim 1, wherein the first and second tracks correspond to one or more bends in the frame assembly.

17. The removable bucket of claim 5, further comprising one or more posts beneath the first and second tracks.

18. The removable bucket of claim 17, wherein the posts are substantially circular in cross section.
